(19) United States
(12) Patent Application Publication
(10) Pub. No.: US 2026/0280022 A1
(43) Pub. Date: Sep. 17, 2026

(54) PORT PLUG FOR A BATTERY CELL

(71) Applicant: GM Global Technology Operations LLC, Detroit, MI (US)

(72) Inventors: David Lubischer, Lake Orion, MI (US); Taeri Kwon, West Bloomfield Township, MI (US); Aaron Schwartz, Royal Oak, MI (US); Hwanchul Kim, Dryden, MI (US)

(21) Appl. No.: 19/081,360

(22) Filed: Mar. 17, 2025

(51) Int. Cl. H01M 50/317; F16K 31/60; H01M 50/103; H01M 50/655

(52) U.S. Cl. CPC H01M 50/317; F16K 31/602; H01M 50/103; H01M 50/655

(57) ABSTRACT

A port plug for degassing a prismatic battery cell includes a wedge, a pipe, and a valve. The wedge is disposed within a fill port of the prismatic battery cell. The wedge includes a top surface, a bottom surface, and a tapered portion. The top surface defines a first opening. The bottom surface opposes the top surface and defines a second opening. The tapered portion is positioned between the top surface and the bottom surface and defines a bore. The bore extends from the first opening to the second opening. The pipe connects to the first opening and to the valve. The valve includes a body and a handle. The body defines an inlet port and an outlet port. The inlet port is attached to the pipe. The handle is connected to the body and adjusts whether the valve is in a closed position or in an open position.

### INTRODUCTION

The present disclosure relates to a port plug for a battery cell. More specifically, the present disclosure relates to a port plug for degassing a prismatic battery cell.

A rechargeable energy storage system (RESS), for example a prismatic battery cell, typically includes a plurality of electrode stacks. Each of the electrode stacks includes an anode and a cathode spaced apart by an electrically insulative separator material. The electrode stacks are placed next to one another typically in a case or enclosure to protect the electrode stacks from the ambient environment. The case also functions to contain an electrolyte fluid within the case and around the electrode stacks. The electrolyte fluid is deposited into the case of the battery cell through a fill port. During manufacturing of the prismatic battery cell an electrolyte fill tool (i.e. a funnel, needle or tube) is inserted into the fill port. The battery cell is filled with the electrolyte fluid through the fill tool. The fill tool is extracted from the fill port and a temporary port plug is positioned in the fill port to prevent the electrolyte fluid from escaping through the fill port.

A non-open formation process is initiated by applying a current to the electrode fluid at a specified time duration. During the non-open formation process, degassing is necessary to prevent swelling and ruptures in the prismatic battery cell. To degas the prismatic battery cell, the temporary port plug is carefully removed to control the release of gas and a bag is placed over the fill port to mitigate the risk of releasing the electrolyte fluid.

Thus, while the current temporary port plug achieves its intended purpose, there is a need for a new and improved port plug for controlled degassing and mitigating the risk of releasing the electrolyte fluid.

### SUMMARY

According to several aspects, a port plug for degassing a prismatic battery cell is provided. The prismatic battery cell defines a fill port. The port plug includes a wedge disposed within the fill port of the prismatic battery cell. The wedge includes a top surface. The top surface defines a first opening. The wedge further includes a bottom surface. The bottom surface defines a second opening. The bottom surface opposes the top surface. The wedge further includes a tapered portion positioned between the top surface and the bottom surface. The tapered portion has a diameter which increases while moving outward from the bottom surface towards the top surface. The tapered portion has a bore that extends from the first opening to the second opening. The port plug further includes a pipe. The pipe includes a first end attached to the first opening of the top surface. The pipe further includes a second end opposing the first end. The port plug further includes a valve. The valve includes a body. The body defines an inlet port and an outlet port. The inlet port is attached to the second end of the pipe. The valve further includes a handle. The handle is connected to the body. The handle adjusts positions of the valve. The positions include a closed position and an open position. The valve is in the closed position when the prismatic battery cell is sealed. The valve is in the open position when the prismatic battery cell is degassed.

In an additional aspect of the present disclosure, the tapered portion creates a pressure against the fill port of the prismatic battery cell. The pressure against the fill port creates a seal.

In another aspect of the present disclosure, the wedge further includes a head. The head is adjacent to the top surface.

In another aspect of the present disclosure, the wedge further includes a flat portion. The flat portion is adjacent to the head. The flat portion is positioned between the head and the tapered portion.

In another aspect of the present disclosure, the flat portion creates a force against the fill port of the prismatic battery cell. The force against the fill port creates a seal.

In another aspect of the present disclosure, the first opening of the top surface of the wedge is threaded.

In another aspect of the present disclosure, the first end of the pipe is threaded. The threading of the first end matches the threading of the first opening, connecting the first end to the first opening of the top surface.

In another aspect of the present disclosure, the pipe is perpendicular to the top surface.

In another aspect of the present disclosure, the port plug further includes a first hose. The first hose is connected to the outlet port of the valve.

In another aspect of the present disclosure, the outlet port is perpendicular to the inlet port.

In another aspect of the present disclosure, the outlet port is parallel to the inlet port.

In another aspect of the present disclosure, the valve further includes a filling port. The filling port is parallel to the outlet port. The outlet port is perpendicular to the inlet port.

In another aspect of the present disclosure, the port plug further includes a second hose. The second hose is connected to the filling port.

According to several aspects, a system for degassing a prismatic battery cell is provided. The system includes the prismatic battery cell. The prismatic battery cell defines a fill port. The system further includes a port plug. The port plug includes a wedge disposed within the fill port of the prismatic battery cell. The wedge includes a top surface. The top surface defines a first opening. The wedge further includes a bottom surface. The bottom surface defines a second opening. The bottom surface opposes the top surface. The wedge further includes a tapered portion positioned between the top surface and the bottom surface. The tapered portion has a diameter which increases while moving outward from the bottom surface towards the top surface. The tapered portion has a bore that extends from the first opening to the second opening. The port plug further includes a pipe. The pipe includes a first end attached to the first opening of the top surface. The pipe further includes a second end opposing the first end. The port plug further includes a valve. The valve includes a body. The body defines an inlet port and an outlet port. The inlet port is attached to the second end of the pipe. The valve further includes a handle. The handle is connected to the body. The handle adjusts positions of the valve. The positions include a closed position and an open position. The valve is in the closed position when the prismatic battery cell is sealed. The valve is in the open position when the prismatic battery cell is degassed. The port plug further includes a first hose. The first hose is connected to the outlet port of the valve.

In another aspect of the present disclosure, the system further includes a first tube. The first tube is connected to the first hose

In another aspect of the present disclosure, the system further includes a container. The container is connected to the first tube.

According to several aspects, a system for degassing a prismatic battery cell is provided. The system includes the prismatic battery cell. The prismatic battery cell defines a fill port. The system further includes a port plug. The port plug includes a wedge disposed within the fill port of the prismatic battery cell. The wedge includes a top surface. The top surface defines a first opening. The wedge further includes a bottom surface. The bottom surface defines a second opening. The bottom surface opposes the top surface. The wedge further includes a tapered portion. The tapered portion is positioned between the top surface and the bottom surface. The tapered portion has a diameter which increases while moving outward from the bottom surface towards the top surface. The tapered portion has a bore that extends from the first opening to the second opening. The port plug further includes a pipe. The pipe includes a first end. The first end is attached to the first opening of the top surface. The pipe further includes a second end opposing the first end. The port plug further includes a valve. The valve includes a body. The body defines an inlet port, an outlet port, and a filling port. The inlet port is attached to the second end of the pipe. The valve further includes a handle. The handle is connected to the body. The handle adjusts positions of the valve. The positions of the valve include a closed position and an open position. The valve is in the closed position when the prismatic battery cell is sealed. The valve is in the open position when the prismatic battery cell is degassed. The port plug further includes a first hose connected to the outlet port of the valve. The port plug further includes a second hose connected to the filling port of the valve. The system further includes a first tube connected to the first hose of the port plug. The system further includes a vacuum pump connected to the first tube.

In another aspect of the present disclosure, the system further includes a second tube. The second tube is connected to the second hose of the port plug.

In another aspect of the present disclosure, the system further includes an electrolyte filling. The electrolyte filling is connected to the second tube.

In another aspect of the present disclosure, the system further includes a filling syringe. The filling syringe is connected to the second tube.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an isometric view of a port plug disposed in a fill port of a prismatic battery cell according to an exemplary embodiment.

FIG. 2A is an isometric view of an alternate embodiment of the port plug disposed in the fill port of the prismatic battery cell according to an exemplary embodiment.

FIG. 2B is an isometric view of an alternate embodiment of the port plug disposed in the fill port of the prismatic battery cell according to an exemplary embodiment.

FIG. 3 is an isometric view of another alternate embodiment of the port plug disposed in the fill port of the prismatic battery cell according to an exemplary embodiment.

FIG. 4 is an isometric view of a system for degassing the prismatic battery cell with the port plug according to an exemplary embodiment.

FIG. 5 is an isometric view of a system for degassing and filling the prismatic battery cell with the port plug according to an exemplary embodiment.

FIG. 6 is an isometric view of an alternate system for degassing and filling the prismatic battery cell with the port plug according to an exemplary embodiment.

### DETAILED DESCRIPTION

The following description is merely exemplary in nature and is not intended to limit the present disclosure, application, or uses.

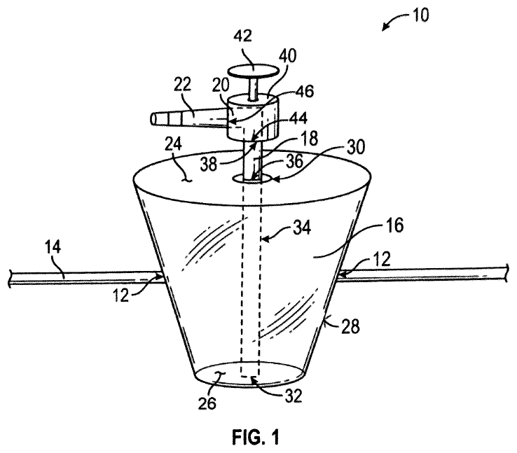

Referring to FIG. 1, an isometric view of a port plug 10 disposed in a fill port 12 of a prismatic battery cell 14 is illustrated. The port plug 10, when disposed in the fill port 12, prevents the prismatic battery cell 14 from releasing gas and electrolytes held within the prismatic battery cell 14. The port plug 10 includes a wedge 16, a pipe 18, a valve 20, and a first hose 22.

The wedge 16 includes a top surface 24, a bottom surface 26, and a tapered portion 28. The top surface 24 defines a first opening 30 and the first opening 30 may be threaded. The threading of the first opening 30 connects the top surface 24 of the wedge 16 to the pipe 18. The bottom surface 26 opposes the top surface 24 and the bottom surface 26 defines a second opening 32. The tapered portion 28 is positioned between the top surface 24 and the bottom surface 26 and includes a bore 34. The bore 34 extends from the first opening 30 to the second opening 32. The tapered portion 28 has a diameter which increases while moving outward from the bottom surface 26 towards the top surface 24.

When the wedge 16 is inserted into the fill port 12, the tapered portion 28 creates a force against the fill port 12. The force by the tapered portion 28 against the fill port 12 is greater than a force created by the gas against the wedge 16, creating and maintaining a seal during degassing of the prismatic battery cell 14. The seal prevents the prismatic battery cell 14 from degassing through the fill port 12 and enables the prismatic battery cell 14 to degas through the bore 34. During degassing, the gas is released from the bore 34 into the pipe 18.

The pipe 18 is positioned perpendicular to the top surface 24 of the wedge 16, allowing the gas to flow through the bore 34 into the pipe 18. The pipe 18 includes a first end 36 and a second end 38. The first end 36 may be threaded. The threading of the first end 36 matches the threading of the first opening 30 of the top surface 24, connecting the first end 36 to the first opening 30. The second end 38 opposes the first end 36 and is connected to the valve 20.

The valve 20 may be, but is not limited to, a ball valve composed of polyethylene plastic. The valve 20 includes a body 40 and a handle 42. The body 40 defines an inlet port 44 and an outlet port 46. The inlet port 44 is positioned parallel to the first opening 30. The inlet port 44 connects to the second end 38 of the pipe 18, allowing gas from the prismatic battery cell 14 to travel through the pipe 18 into the inlet port 44. From the inlet port 44, the gas is released from the valve 20 through the outlet port 46. The outlet port 46 is positioned perpendicular to the first opening 30. The position of the outlet port 46 allows the outlet port 46 to connect to the first hose 22 without increasing the height of the port plug 10, ensuring the port plug 10 fits in a formation chamber. The first hose 22 is described in further detail below.

The handle 42 is connected to the body 40 and is positioned parallel to the inlet port 44. The handle 42 controls the gas flow by adjusting positions of the valve 20. The positions of the valve 20 include an open position and a closed position. The valve 20 is in the open position when the prismatic battery cell 14 is degassed, causing the gas to flow from the prismatic battery cell 14 through the outlet port 46. The valve 20 is in the closed position when the prismatic battery cell 14 is sealed and the gas is unable to flow from the inlet port 44 through the outlet port 46.

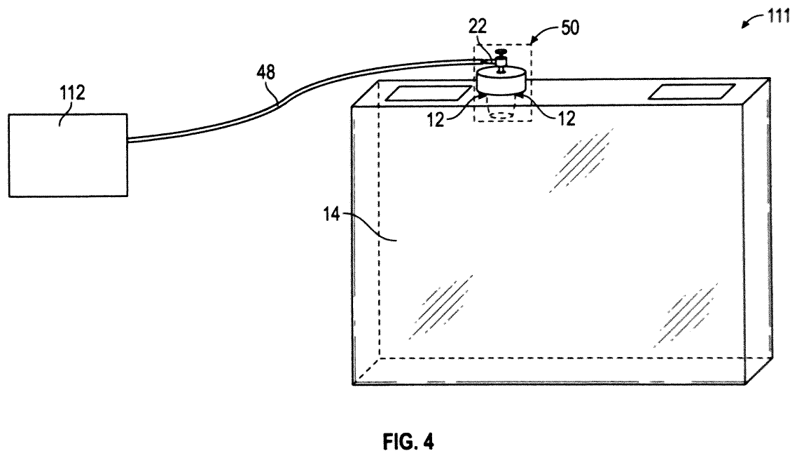

The first hose 22 is connected to the outlet port 46. The first hose 22 may be composed of, but is not limited to, polyethylene plastic. The first hose 22 is hollow, allowing the gas from the prismatic battery cell 14 to be released from the outlet port 46 through the first hose 22. The first hose 22 may be barbed, allowing for the first hose 22 to connect to a first tube 48 (shown in FIG. 4) to release the gas into a predetermined location.

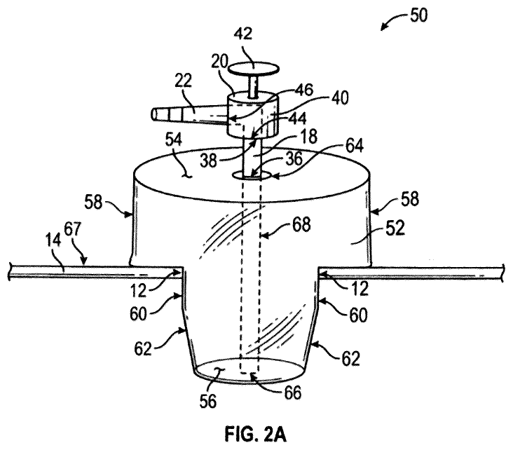

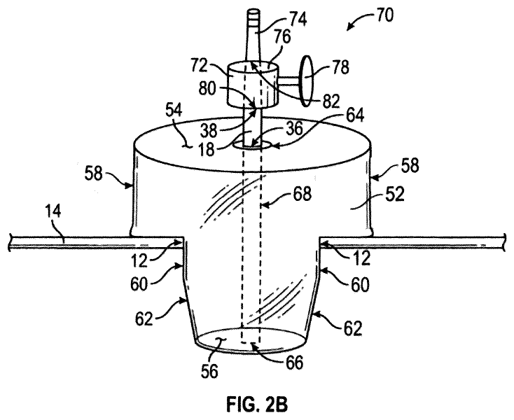

Referring to FIG. 2A, an isometric view of an alternate embodiment of the port plug 10, indicated by reference number 50, disposed in the fill port 12 of the prismatic battery cell 14 is illustrated. The port plug 50 includes the pipe 18, the valve 20, and the first hose 22 shown in FIG. 1. The port plug 50 further includes a wedge 52. The wedge 52 includes a top surface 54, a bottom surface 56, a head 58, a flat portion 60, and a tapered portion 62.

The top surface 54 defines a first opening 64 and the first opening 64 may be threaded, connecting the top surface 54 to the pipe 18. The bottom surface 56 opposes the top surface 54 and the bottom surface 56 defines a second opening 66. The head 58 is positioned adjacent to the top surface 54 and acts as a stopper. The head 58 stops the wedge 52 from being inserted further into the fill port 12. For example, when the wedge 52 is fully inserted into the fill port 12, the head 58 is in contact and becomes flush with a surface 67 of the prismatic battery cell 14. The flat portion 60 is adjacent to the head 58 and is in contact with the fill port 12. The tapered portion 62 is positioned between the bottom surface 56 and the flat portion 60. The tapered portion 62 has a diameter which increases while moving outward from the bottom surface 56 to the flat portion 60. The tapered portion 62, the flat portion, and the head 58 define a bore 68 which extends from the first opening 64 to the second opening 66.

When the wedge 52 is inserted into the fill port 12, the flat portion 60 is in contact with the fill port 12, creating a force against the fill port 12. The force against the fill port 12 by the flat portion 60 is greater than a force created by the gas against the wedge 52, creating and maintaining a seal during degassing. The seal enables the prismatic battery cell 14 to degas through the bore 68 of the wedge 52 and prevents the prismatic battery cell 14 to degas through the fill port 12.

Referring to FIG. 2B, an isometric view of an alternate embodiment of the port plug 50, indicated by reference number 70, disposed in the fill port 12 of the prismatic battery cell 14 is illustrated. The port plug 70 includes the wedge 52 and the pipe 18 as shown in FIG. 2A. The port plug 70 further includes a valve 72 and a first hose 74.

The valve 72 may be, but is not limited to, a ball valve composed of polyethylene plastic. The valve 72 includes a body 76 and a handle 78. The body 76 defines an inlet port 80 and an outlet port 82. The inlet port 80 is positioned parallel to the first opening 64. The inlet port 80 connects to the second end 38 of the pipe 18, allowing gas from the prismatic battery cell 14 to travel through the pipe 18 into the inlet port 80. From the inlet port 80, the gas is released from the valve 72 through the outlet port 82. The outlet port 82 is positioned parallel to the inlet port 80. The position of the outlet port 82 allows for electrolytes lost during degassing to reenter the prismatic battery cell.

The handle 78 is connected to the body 76. The handle 78 is positioned perpendicular to the top surface 54 of the wedge 52. The handle 78 controls the gas flow by adjusting positions of the valve 72. The positions of the valve 72 include an open position and a closed position. The valve 72 is in the open position when the prismatic battery cell 14 is degassed, causing the gas to flow from the prismatic battery cell 14 through the outlet port 82. The valve 72 is in the closed position when the prismatic battery cell 14 is sealed and the gas is unable to flow from the inlet port 80 through the outlet port 82.

The first hose 74 is connected to the outlet port 82. The first hose 74 is hollow, allowing the gas from the prismatic battery cell 14 to be released from the outlet port 82 through the first hose 74. The first hose 74 may be, but is not limited to, composed of polyethylene plastic and barbed. The barbing of the first hose 74 allows for the first hose 74 to connect to a first tube 48 (shown in FIG. 4) to release the gas into a predetermined location.

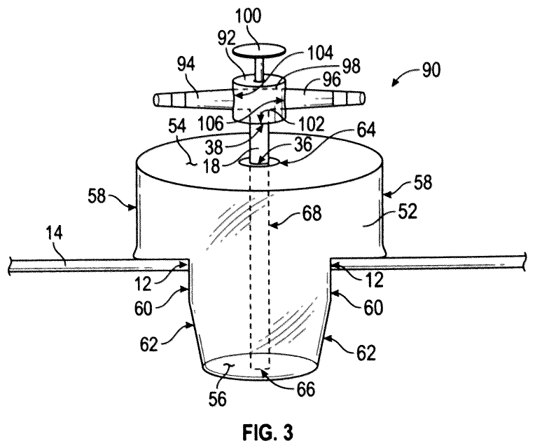

Referring to FIG. 3, an isometric view of an alternate embodiment of the port plug 50, indicated by reference number 90, disposed in the prismatic battery cell 14 is illustrated. The port plug 90 includes the wedge 52 and the pipe 18 as shown in FIG. 2A. The port plug 90 further includes a valve 92, a first hose 94, and a second hose 96.

The valve 92 may be, but is not limited to, a ball valve composed of polyethylene plastic. The valve 92 includes a body 98 and a handle 100. The body 98 defines an inlet port 102, an outlet port 104, and a filling port 106. The inlet port 102 is positioned parallel to the first opening 64. The inlet port 102 connects to the second end 38 of the pipe 18, allowing gas from the prismatic battery cell 14 to travel through the pipe 18 into the inlet port 102. From the inlet port 102, the gas is released from the valve 92 through the outlet port 104. After the prismatic battery cell 14 releases the gas, the prismatic battery cell 14 may be filled with electrolytes that travel through the filling port 106. The outlet port 104 is positioned perpendicular to the inlet port 102 and the filling port 106 is positioned parallel to the outlet port 104. The position of the outlet port 104 and the filling port 106 allows the outlet port 104 to connect to the first hose 94 and the filling port 106 to connect to the second hose 96 without increasing the height of the port plug 10, ensuring the port plug 10 fits in the formation chamber. The first hose 94 and the second hose 96 are described in further detail below.

The handle 100 is connected to the body 98. The handle 100 is positioned parallel to the top surface 54 of the wedge 52. The handle 100 controls the gas flow by adjusting positions of the valve 92. The positions of the valve 92 include an open position, a closed position, and a filling position. The valve 92 is in the open position when the prismatic battery cell 14 is degassed, causing the gas to flow from the prismatic battery cell 14 through the outlet port 104. The valve 92 is in the closed position when the prismatic battery cell 14 is sealed and the gas is unable to flow through the outlet port 104. The valve 92 is in the filling position when electrolytes, from an external source, flow through the filling port 106, through the pipe 18, and into the prismatic battery cell 14.

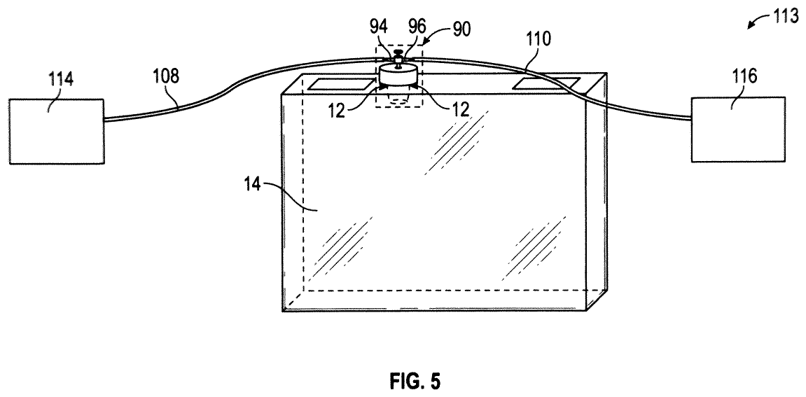

The first hose 94 is connected to the outlet port 104 and is perpendicular to the top surface 54 of the wedge 52. The second hose 96 is connected to the filling port 106 and is perpendicular to the top surface 54 of the wedge 52. The first hose 94 and the second hose 96 may be composed of, but are not limited to, polyethylene plastic. The first hose 94 is hollow, allowing the gas from the prismatic battery cell 14 to be released from the outlet port 104 through the first hose 94. The second hose 96 is hollow, allowing electrolytes to enter the prismatic battery cell 14 through the second hose 96. The first hose 94 and the second hose 96 may be barbed, allowing the first hose 94 to connect to a first tube 108 (shown in FIG. 5) and allowing the second hose 96 to connect to a second tube 110 (shown in FIG. 5).

Referring to FIG. 4, an isometric view of a system 111 for degassing the prismatic battery cell 14 with the port plug 50 is illustrated. Degassing is necessary to prevent the prismatic battery cell 14 from swelling and rupturing. The system 111 includes the port plug 50, the first tube 48, and a container 112.

The port plug 50 is inserted into the fill port 12 of the prismatic battery cell 14 and creates a seal against the fill port 12. During degassing, the port plug 50 is in the open position, which allows the gas from the prismatic battery cell 14 to be released through the port plug 50. The first tube 48 is connected to the first hose 22 of the port plug 50 and to the container 112. The gas travels through port plug 50 and is released from the port plug 50 through the first hose 22 and into the first tube 48. The gas travels through the first tube 48 and is then released from the first tube 48 and is stored within the container 112. The container 112 creates a predetermined location for the gas and hazardous electrolytes to be contained.

Referring to FIG. 5, an isometric view of a system 113 for degassing and filling the prismatic battery cell 14 with the port plug 90 is illustrated. Degassing is necessary to prevent the prismatic battery cell 14 from swelling and rupturing. During the degassing process, electrolytes may be released from the prismatic battery cell 14. The prismatic battery cell 14 is filled with electrolytes to replenish the prismatic battery cell 14 with electrolytes lost during degassing. The system 113 includes the port plug 90, the first tube 108, the second tube 110, a vacuum pump 114, and an electrolyte filling 116.

The port plug 90 is inserted into the fill port 12 of the prismatic battery cell 14 and creates a seal against the fill port 12. During degassing, the port plug 90 is in the open position, allowing the gas from the prismatic battery cell 14 to be released through the port plug 90. The first tube 108 is connected to the first hose 94 of the port plug 90 and to the vacuum pump 114. The vacuum pump removes the gas from the prismatic battery cell 14 and creates a low-pressure environment in the prismatic battery cell 14. The gas travels from the prismatic battery cell 14, through the port plug 90, and through the first tube 108. The gas is then released from the first tube 108 and enters the vacuum pump 114. The vacuum pump 114 releases the gas into the surrounding environment.

After degassing, the prismatic battery cell 14 is filled with electrolytes without the removal of the port plug 90. To fill the prismatic battery cell 14, the port plug is in the filling position, allowing electrolytes from the electrolyte filling 116 to enter the prismatic battery cell 14. The electrolyte filling 116 is connected to the second tube 110. The second tube 110 is also connected to the second hose 96 of the port plug 90. Due to the low-pressure environment in the prismatic battery cell 14, created by the vacuum pump 114, the electrolytes travel from the electrolyte filling 116, through the second tube 110, and through the port plug 90. The electrolytes are then released from the port plug and enter the prismatic battery cell 14. The electrolyte filling 116 replenishes the prismatic battery cell 14 with electrolytes after losing electrolytes during the degassing process.

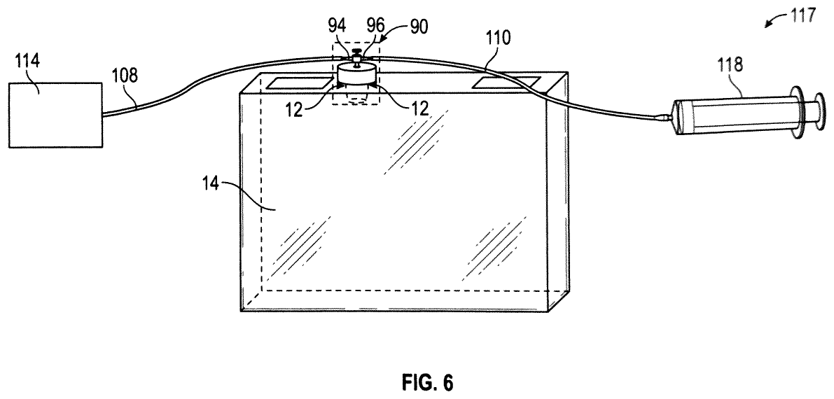

Referring to FIG. 6, an isometric view of an alternate system 113 for degassing and filling the prismatic battery cell 14, indicated by reference number 117, with the port plug 90 is illustrated. Degassing is necessary to prevent the prismatic battery cell 14 from swelling and rupturing. During the degassing process, electrolytes may be released from the prismatic battery cell 14. Without the removal of the port plug 90, the prismatic battery cell 14 is filled with electrolytes to replenish the prismatic battery cell 14 with electrolytes lost during degassing. The system 117 includes the port plug 90, the first tube 108, the second tube 110, and the vacuum pump 114 shown in FIG. 5. The system 117 further includes a filling syringe 118.

The filling syringe 118 is connected to the second tube 110. The filling syringe 118 is filled with electrolytes and releases electrolytes into the second tube 110. Due to the low-pressure environment of the prismatic battery cell 14, created by the vacuum pump 114, the electrolytes travel through the second tube 110 and into the port plug 90. While the port plug 90 is in the filling position, the electrolytes travel through the port plug 90 and enter the prismatic battery cell 14, replenishing the prismatic battery cell 14 with electrolytes after losing electrolytes during the degassing process.

The port plug 10, 50, 70, and 90 of the present disclosure offers several advantages. These include mitigating the risk of releasing hazardous electrolytes during the degassing process and controlling the release of the gas from the prismatic battery cell 14. In the system 111 for degassing the prismatic battery cell, the gas is released and stored in a predetermined location such as the container 112. In addition, the system 113 and 117 for degassing and filling the prismatic battery cell 14 with the port plug 90 allows for a controlled degassing of the prismatic battery cell 14 and a means to refill the prismatic battery cell 14 with electrolytes after the degassing process without removing the port plug 90.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A port plug for degassing a prismatic battery cell, the prismatic battery cell defining a fill port, the port plug comprising:
a wedge disposed within the fill port of the prismatic battery cell, the wedge including:
a top surface defining a first opening;
a bottom surface defining a second opening, the bottom surface opposing the top surface; and
a tapered portion positioned between the top surface and the bottom surface and wherein a diameter of the tapered portion increases while moving outward from the bottom surface towards the top surface, the tapered portion having a bore that extends from the first opening to the second opening;
a pipe including:
a first end attached to the first opening of the top surface; and
a second end opposing the first end; and
a valve including:
a body defining an inlet port and an outlet port and wherein the inlet port is attached to the second end of the pipe; and
a handle connected to the body and wherein the handle adjusts positions of the valve, the positions including a closed position and an open position, and
wherein when the valve is in the closed position, the prismatic battery cell is sealed, and when the valve is in the open position, the prismatic battery cell is degassed.

2. The port plug of claim 1, wherein the tapered portion creates a pressure against the fill port of the prismatic battery cell and wherein the pressure against the fill port creates a seal.

3. The port plug of claim 1, wherein the wedge further comprises a head and wherein the head is adjacent to the top surface.

4. The port plug of claim 3, wherein the wedge further comprises a flat portion, wherein the flat portion is adjacent to the head, and wherein the flat portion is positioned between the head and the tapered portion.

5. The port plug of claim 4, wherein the flat portion creates a force against the fill port of the prismatic battery cell and wherein the force against the fill port creates a seal.

6. The port plug of claim 1, wherein the first opening of the top surface of the wedge is threaded.

7. The port plug of claim 6, wherein the first end of the pipe is threaded and wherein the threading of the first end matches the threading of the first opening, connecting the first end to the first opening of the top surface.

8. The port plug of claim 1, wherein the pipe is perpendicular to the top surface.

9. The port plug of claim 1, further comprising a first hose, wherein the first hose is connected to the outlet port of the valve.

10. The port plug of claim 1, wherein the outlet port is perpendicular to the inlet port.

11. The port plug of claim 1, wherein the outlet port is parallel to the inlet port.

12. The port plug of claim 1, wherein the valve further comprises a filling port, wherein the filling port is parallel to the outlet port, and wherein the outlet port is perpendicular to the inlet port.

13. The port plug of claim 12, further comprises a second hose and wherein the second hose is connected to the filling port.

14. A system for degassing a prismatic battery cell, the system comprising:
the prismatic battery cell, wherein the prismatic battery cell defines a fill port; and
a port plug, the port plug including:
a wedge disposed within the fill port of the prismatic battery cell, the wedge including:
a top surface defining a first opening;
a bottom surface defining a second opening, the bottom surface opposing the top surface; and
a tapered portion positioned between the top surface and the bottom surface and wherein a diameter of the tapered portion increases while moving outward from the bottom surface towards the top surface, the tapered portion having a bore that extends from the first opening to the second opening;
a pipe including:
a first end attached to the first opening of the top surface; and
a second end opposing the first end;
a valve including:
a body defining an inlet port and an outlet port and wherein the inlet port is attached to the second end of the pipe; and
a handle connected to the body and wherein the handle adjusts positions of the valve, the positions including a closed position and an open position,
wherein when the valve is in the closed position, the prismatic battery cell is sealed, and when the valve is in the open position, the prismatic battery cell is degassed; and
a first hose connected to the outlet port of the valve.

15. The system of claim 14, further comprising a first tube, wherein the first tube is connected to the first hose.

16. The system of claim 15, further comprising a container, wherein the container is connected to the first tube.

17. A system for degassing a prismatic battery cell, the system comprising:
the prismatic battery cell, wherein the prismatic battery cell defines a fill port;
a port plug, the port plug including:
a wedge disposed within the fill port of the prismatic battery cell, the wedge including:
a top surface defining a first opening;
a bottom surface defining a second opening, the bottom surface opposing the top surface; and
a tapered portion positioned between the top surface and the bottom surface and wherein a diameter of the tapered portion increases while moving outward from the bottom surface towards the top surface, the tapered portion having a bore that extends from the first opening to the second opening;
a pipe including:
a first end attached to the first opening of the top surface; and
a second end opposing the first end;
a valve including:
a body defining an inlet port, an outlet port, and a filling port, wherein the inlet port is attached to the second end of the pipe; and
a handle connected to the body and wherein the handle adjusts positions of the valve, the positions including a closed position and an open position,
wherein when the valve is in the closed position, the prismatic battery cell is sealed, and when the valve is in the open position, the prismatic battery cell is degassed;
a first hose connected to the outlet port of the valve; and
a second hose connected to the filling port of the valve;
a first tube connected to the first hose of the port plug; and
a vacuum pump connected to the first tube.

18. The system of claim 17, further comprising a second tube, wherein the second tube is connected to the second hose of the port plug.

19. The system of claim 18, further comprising an electrolyte filling, wherein the electrolyte filling is connected to the second tube.

20. The system of claim 18, further comprising a filling syringe, wherein the filling syringe is connected to the second tube.
